(19) United States
(12) Patent Application Publication
(10) Pub. No.: US 2026/0322003 A1
(43) Pub. Date: Oct. 15, 2026

(54) TERMINATIONS AND SHIELDS FOR HIGH-SPEED CABLE ASSEMBLIES

(71) Applicant: Molex, LLC, Lisle, IL (US)

(72) Inventors: Arturo Casares Valdes, Conway, AR (US); David Arthur Burns, Brookfield, IL (US); Seyed Mostafa Mousavi, Chicago, IL (US); Michael Garrison, Russellville, AR (US)

(21) Appl. No.: 19/635,841

(22) Filed: Apr. 1, 2026

Related U.S. Application Data
(60) Provisional application No. 63/789,218, filed on Apr. 15, 2025.

(51) Int. Cl. H01R 12/53

(52) U.S. Cl. CPC H01R 12/53

(57) ABSTRACT

A high-speed cable assembly includes a printed circuit board, a twinax cable, a bottom shield array comprising a plurality of individual bottom shields, and a top shield. Each bottom shield is a U-shaped conductive material positioned around the twinax cable to shield the twinax cable on three sides. The top shield is configured to be electrically connected to the bottom shield array. The assembly may further include a conductive foam electrically connecting the top shield to a twinax foil of the twinax cable. The twinax cable may include a pair of signal conductors and a pair of ground conductors mounted to conductive pads of the printed circuit board. A stabilizer bar may be positioned between the top shield and bodies of the twinax cable to stabilize terminations to the printed circuit board.

### TECHNICAL FIELD

The present disclosure generally relates to high-speed cable assemblies and, in particular, to cable assemblies featuring shield arrays for improving signal integrity in high-speed cable assemblies.

### BACKGROUND

High-speed cable assemblies play a critical role in modern electronic systems, enabling rapid data transmission across various devices and networks. As data rates continue to increase, maintaining signal integrity becomes increasingly challenging. Cable assemblies operating at high frequencies are susceptible to electromagnetic interference, crosstalk, and other signal degradation factors that can compromise performance and reliability. Shielding techniques have been employed to mitigate these issues in high-speed cable assemblies. However, as data rates push into higher frequency ranges, such as those used in OSFP 224G applications and beyond, traditional shielding methods may not provide adequate protection.

### BRIEF SUMMARY

According to an aspect of the present disclosure, a high-speed cable assembly is provided. The high-speed cable assembly includes a printed circuit board. The assembly also includes a twinax cable having a pair of signal conductors and/or a pair of ground conductors mounted to conductive pads on the printed circuit board. The assembly further includes a bottom shield comprising a U-shaped conductive material positioned around the twinax cable to shield the pair of signal conductors and the pair of ground conductors on three sides. Additionally, the assembly includes a top shield electrically connected to the bottom shield.

The assembly may further comprise a conductive foam or conductive thermal paste electrically connecting the top shield to a twinax foil of the twinax cable. The printed circuit board may comprise multiple layers, at least a portion of the layers each having a unique geometry. The assembly may further comprise a stabilizer bar positioned between the top shield and a body of the twinax cable to stabilize terminations to the printed circuit board. The bottom shield may comprise at least one tab projecting from a wall thereof for electrical connection to the top shield. The top shield may comprise a notch configured to interface with the tab of the bottom shield. The twinax cable may comprise a cut-out area on a jacket that exposes a twinax foil. The cut-out area may be positioned to align with a conductive material on a bottom surface of the top shield. The printed circuit board may comprise a trough configured to accommodate a portion of the twinax cable.

According to another aspect of the present disclosure, a high-speed cable assembly is provided. The high-speed cable assembly includes a printed circuit board having a trough. The assembly also includes a twinax cable partially nested within the trough of the printed circuit board, the twinax cable having a jacket with a cut-out area exposing a twinax foil. The assembly further includes a bottom shield comprising a U-shaped conductive material positioned around the twinax cable. Additionally, the assembly includes a top shield and a conductive material electrically connecting the top shield to the exposed twinax foil.

The conductive material may comprise a conductive foam or a conductive thermal paste. The bottom shield may comprise a tab projecting from a wall thereof for electrical connection to the top shield, and the top shield may comprise a notch configured to interface with the tab or extension of the bottom shield. The twinax cable may comprise a pair of signal conductors and a pair of ground conductors mounted to conductive pads on the printed circuit board. The signal conductors and ground conductors may be bent downwards and outward from one another. The assembly may further comprise a stabilizer bar positioned between the top shield and a body of the twinax cable to stabilize terminations to the printed circuit board. The stabilizer bar may be overmolded between the top shield and the body of the twinax cable. The printed circuit board may comprise multiple layers, each layer having a unique geometry.

According to yet another aspect of the present disclosure, a high-speed cable assembly is provided. The high-speed cable assembly includes a printed circuit board. The assembly also includes a twinax cable mounted to the printed circuit board. The assembly further includes a bottom shield comprising a U-shaped conductive material positioned around the twinax cable. Additionally, the assembly includes a top shield, a retention bar positioned on the printed circuit board to maintain the bottom shield, and a stabilizer bar positioned between the top shield and a body of the twinax cable.

The twinax cable may comprise a pair of signal conductors and a pair of ground conductors mounted to conductive pads on the printed circuit board. The signal conductors and ground conductors may be bent downwards and outward from one another. The twinax cable may comprise a jacket with a cut-out area exposing a twinax foil. The assembly may further comprise a conductive material electrically connecting the top shield to the exposed twinax foil. The conductive material may comprise a conductive foam. The printed circuit board may comprise a trough configured to accommodate a portion of the twinax cable.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a high-speed cable assembly according to various embodiments of the present disclosure.

FIG. 2 is a top perspective view of the high-speed cable assembly of FIG. 1 with a top shield thereof omitted according to various embodiments of the present disclosure.

FIGS. 3 and 4 are top perspective views of a termination region of the high-speed cable assembly of FIG. 2 with a top shield thereof omitted according to various embodiments of the present disclosure.

FIG. 5 is a conductive printed circuit board layer for use in the high-speed cable assembly according to various embodiments of the present disclosure.

FIG. 6 is a top elevation view of the high-speed cable assembly of FIG. 1 with a top shield thereof omitted according to various embodiments of the present disclosure.

FIG. 7 is a top elevation view of a printed circuit board having a multitude of bottom shields contained by multiple retention bars according to various embodiments of the present disclosure.

FIG. 8 is a side, sectional view of the printed circuit board of FIG. 7 according to various embodiments of the present disclosure.

FIG. 9 is a top perspective view of a twinax cable for use in the high-speed cable assembly according to various embodiments of the present disclosure.

FIG. 10 is a top elevation view of the twinax cable for use in the high-speed cable assembly according to various embodiments of the present disclosure.

FIGS. 11A and 11B are bottom perspective views of a top shield for use in the high-speed cable assembly according to various embodiments of the present disclosure.

FIG. 12 is a top elevation view of the top shield for use in the high-speed cable assembly according to various embodiments of the present disclosure.

FIG. 13 is a bottom elevation view of the top shield for use in the high-speed cable assembly according to various embodiments of the present disclosure.

FIG. 14 is a rear, top perspective view of the high-speed cable assembly featuring a stabilizer bar according to various embodiments of the present disclosure.

FIG. 15 is a rear elevation view of the high-speed cable assembly featuring the stabilizer bar according to various embodiments of the present disclosure.

FIG. 16 is a top perspective view of a high-speed cable assembly according to various embodiments of the present disclosure.

FIG. 17 is a top perspective view of the high-speed cable assembly of FIG. 16 with a top shield thereof omitted according to various embodiments of the present disclosure.

FIG. 18 is a top perspective view of a high-speed cable assembly featuring a ground shield and a retention device according to various embodiments of the present disclosure.

FIG. 19 is a top perspective view of the high-speed cable assembly of FIG. 18 with the ground shield omitted according to various embodiments of the present disclosure.

FIG. 20 is a top perspective view of the high-speed cable assembly of FIG. 18 with the ground shield and the retention device omitted according to various embodiments of the present disclosure.

FIG. 21 is a top elevation view of the high-speed cable assembly of FIG. 18 with the ground shield and the retention device omitted according to various embodiments of the present disclosure.

FIG. 22 is a side elevation view of the high-speed cable assembly of FIG. 18 with the ground shield and the retention device omitted according to various embodiments of the present disclosure.

FIG. 23 is a top perspective view of a high-speed cable assembly featuring a ground shield and a retention device according to various embodiments of the present disclosure.

FIG. 24 is a side elevation view of the high-speed cable assembly of FIG. 23 with the ground shield omitted according to various embodiments of the present disclosure.

FIG. 25 is a top perspective view of the high-speed cable assembly of FIG. 23 with the ground shield and the retention device omitted according to various embodiments of the present disclosure.

FIG. 26 is a top elevation view of the high-speed cable assembly of FIG. 23 with the ground shield omitted according to various embodiments of the present disclosure.

FIG. 27 is a side elevation view of the high-speed cable assembly of FIG. 23 with the ground shield and the retention device omitted according to various embodiments of the present disclosure.

FIG. 28 is a top elevation view of the high-speed cable assembly of FIG. 23 with the ground shield and the retention device omitted according to various embodiments of the present disclosure.

FIG. 29 is a top perspective view of a high-speed cable assembly featuring a ground shield and a retention device according to various embodiments of the present disclosure.

FIG. 30 is a side elevation view of the high-speed cable assembly of FIG. 29 with the ground shield omitted according to various embodiments of the present disclosure.

FIG. 31 is a top elevation view of the high-speed cable assembly of FIG. 29 with the ground shield omitted according to various embodiments of the present disclosure.

FIG. 32 is a top perspective view of the high-speed cable assembly of FIG. 29 with the ground shield and the retention device omitted according to various embodiments of the present disclosure.

FIG. 33 is a top perspective view of a high-speed cable assembly featuring a retention device according to various embodiments of the present disclosure.

FIG. 34 is a top elevation view of the high-speed cable assembly of FIG. 33 according to various embodiments of the present disclosure.

FIG. 35 is a side elevation view of the high-speed cable assembly of FIG. 33 according to various embodiments of the present disclosure.

FIG. 36 is a top perspective view of a high-speed cable assembly featuring a retention device according to various embodiments of the present disclosure.

FIG. 37 is a top elevation view of the high-speed cable assembly of FIG. 36 according to various embodiments of the present disclosure.

FIG. 38 is a top perspective view of a high-speed cable assembly featuring a bottom shield and a retention device having a wedge-shaped bottom section according to various embodiments of the present disclosure.

### DETAILED DESCRIPTION

The present disclosure relates to a shield array for high-speed cable assemblies and, more specifically, described an array of bottom shields that can be used to provide improved signal integrity (SI) performance, among other benefits. High-speed cable assemblies, particularly those involving twinax cables connected to substrates, may face numerous challenges in maintaining signal integrity and performance. As data rates increase, issues such as electromagnetic interference, crosstalk, and signal degradation become more pronounced. Traditional connector designs may struggle to provide adequate shielding and stability for the delicate terminations between the cable and substrate.

In applications pushing towards 224 Gb/s and beyond, these challenges are further amplified. The extremely high frequencies involved make the cable assembly more susceptible to external noise sources and internal signal coupling. Additionally, maintaining consistent impedance and minimizing signal reflections becomes increasingly difficult at these data rates. The physical layout and shielding of the cable terminations play a crucial role in overall system performance.

Accordingly, various embodiments are described herein for a high-speed cable assembly having improved signal integrity performance. A high-speed cable assembly can include a printed circuit board, one or more twinax cables, a bottom shield for each of the twinax cables forming an array, and a top shield. The bottom shield array includes multiple individual U-shaped conductive shields corresponding to each of the twinax cables. The U-shaped conductive shields are positioned around the twinax cable to provide shielding on three sides, for example. The top shield can be electrically connected to the bottom shield array through various methods such as soldering, laser welding, crimping, or interference fit. The assembly may also include a conductive material, such as a conductive foam, that electrically connects the top shield to a conductive foil of a twinax cable, which can be exposed through an opening in the cable jacket.

In some implementations, the twinax cable in the assembly includes signal conductors mounted to or otherwise electrically coupled to conductive pads on the printed circuit board using a hot bar or like connection process. The printed circuit board may have multiple layers with varying geometries to accommodate these conductors. A stabilizer bar may be positioned between the top shield and the twinax cable bodies to stabilize the terminations to the printed circuit board. In some embodiments, the stabilizer bar may be overmolded between the top shield and the twinax cable bodies.

A bottom shield array retention bar can hold or otherwise maintain the individual bottom shields in a desired arrangement, where the retention bar can be formed of a non-conductive material. The conductive material, such as conductive foam, may be applied to stamped or formed sections of the top shield to create a conductive connection with a twinax foil of a twinax cable. The assembly according to various embodiments described herein is designed to address challenges in maintaining signal integrity and performance in high-speed applications, particularly those approaching data rates of 224 Gb/s and beyond, where issues such as electromagnetic interference, crosstalk, and signal degradation become more significant.

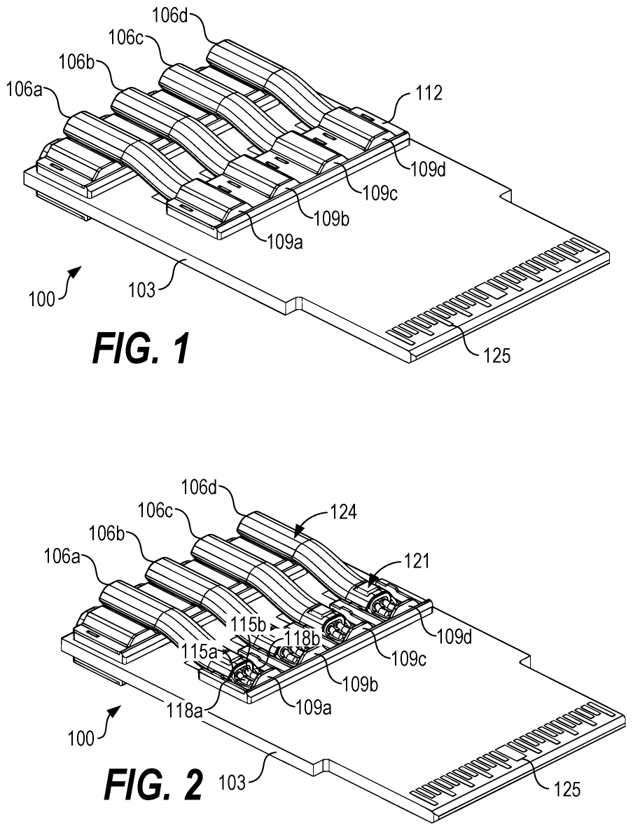

Turning now to the drawings, FIG. 1 shows a top perspective view of a non-limiting example of a high-speed cable assembly 100 according to various embodiments. The high-speed cable assembly 100 includes a printed circuit board 103 have a multitude of twinax cables 106a . . . 106d (collectively “twinax cables 106”) affixed thereto. While there can be multiple rows of twinax cables 106 affixed to different regions of the printed circuit board 103, for the sake of convenience, termination of a single row of twinax cables 106a . . . 106d is described. The high-speed cable assembly 100 can include one or more bottom shields 109a . . . 109d (collectively “bottom shields 109”). In some embodiments, the bottom shields 109 are in a one-to-one corresponding with a twinax cable 106. Thus, each of the twinax cables 106 in the high-speed cable assembly 100 can include a corresponding bottom shield 109. The high-speed cable assembly 100 can include a top shield 112 which can be affixed to a top surface of the one or more bottom shields 109, as will be described.

FIG. 2 shows the same perspective view of FIG. 1, with the top shield 112 omitted for explanatory purposes. Referring to FIGS. 1 and 2 collectively, each twinax cable 106 can include signal conductors 115a, 115b (collectively “signal conductors 115”). In some implementations, however, each twinax cable 106 can include signal conductors 115 and ground conductors 118a, 118b (collectively “ground conductors 118”).

The signal conductors 115 and ground conductors 118 can be mounted to conductive pads on the printed circuit board 103 or otherwise terminated for signal communication and grounding, respectively, using various techniques. In some implementations, a hot bar process, also referred to as hot bar soldering, can be employed to create reliable connections between the conductors 115, 118 and the pads. Alternatively, laser soldering may be employed. In some embodiments, the ground conductors 118 are not terminated to the printed circuit board 103 and, instead, can be terminated to another conductive structure which, in turn, can be grounded to the printed circuit board 103.

In some embodiments, each twinax cable 106 may include a conductive twinax foil 121 that provides electromagnetic shielding for the internal conductors. The twinax foil 121 may be exposed through an opening or cut-out in the jacket 124 of the twinax cable 106 in a location corresponding to the top shield 112. The exposure of the twinax foil 121 can allow for electrical connection to other components of the assembly, such as the top shield 112 and/or a conductive material positioned therebetween, which may enhance overall shielding effectiveness and signal integrity. The location and size of the opening in the jacket 124 can be designed to optimize the electrical connection while maintaining the mechanical integrity of the twinax cable 106. In some cases, the exposed portion of the twinax foil 121 can be selectively treated or prepared to improve conductivity or adhesion with other conductive elements in the assembly 100.

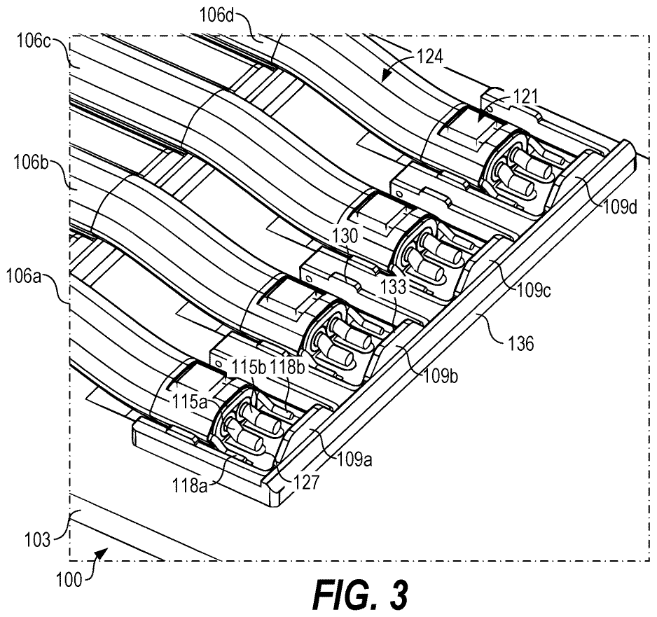

FIG. 3 shows an enlarged top perspective view of a termination of the twinax cables 106 to the printed circuit board 103. In FIG. 3, the bottom shields 109 include U-shaped conductive material formed a U-shaped wall surrounding the termination of the twinax cables 106. Each of the twinax cables 106 can thus terminate in an area enclosed by the U-shaped conductive material, where the bottom shields 109 surround the conductors 115, 118 and the termination region. Each bottom shield 109 may be positioned to enclose the corresponding twinax cable 106 on three sides, providing electromagnetic shielding for the termination area. This arrangement can assist with signal integrity by reducing electromagnetic interference and crosstalk between adjacent cable terminations. The open top of the bottom shields 109 may allow for visual inspection of the terminations and provide access for additional shielding components, such as the top shield 112 (not shown in FIG. 3).

In some implementations, the bottom shields 109 are formed from a conductive material, such as metal, and may be bent or otherwise precisely shaped to closely fit around the twinax cables 106 and their associated conductors 115, 118. The bottom shields 108 may extend upwards from the printed circuit board 103, creating three sidewalls that flank the conductors 115, 118 on either side.

In some embodiments, the printed circuit board 103 may operate as a paddle card, where signals communicated over the signal conductors 115 can be processed and transmitted via conductive pads 125 located on a distal end of the substrate of the printed circuit board 103. The paddle card configuration may allow for signal routing and processing within the compact form factor of the high-speed cable assembly 100.

The conductive pads 125 on the distal end of the printed circuit board 103 may serve as an interface for connecting the assembly to other components or systems. This arrangement may enable the printed circuit board 103 to act as both a termination point for the twinax cables 106 and a signal processing device. The paddle card thus may incorporate various circuit elements, such as amplifiers, equalizers, or other signal conditioning components, to optimize signal quality before transmission through the conductive pads 125. Additionally, the paddle card may provide flexibility in system integration, allowing the high-speed cable assembly 100 to be easily inserted into or removed from a larger electronic system or device.

Further, FIG. 3 shows conductive termination pads 127 of the printed circuit board 103. The signal conductors 115 and ground conductors 118 emerge from the twinax cables 106 and connect to their respective conductive termination pads 127 on the printed circuit board 103. The U-shaped bottom shields 109 may be designed to accommodate the geometry of the terminations of the conductors 115, 118, providing optimal shielding while allowing for proper electrical connections.

In some embodiments, the bottom shields 109 include tabs 130 or extensions 133 formed in one or more walls thereof that facilitate the attachment of the bottom shields 109 to the top shield 112 or their electrical connection to other shielding components. The precise dimensions and shape of the U-shaped bottom shields 109 may be tailored to the specific requirements of the high-speed cable assembly, taking into account factors such as signal frequency, cable size, and overall assembly geometry. While various embodiments show a twinax cable 106 with a 24 gauge (e.g., 24 AWG) size, it is understood that other cable sizes and types can be employed.

In some embodiments, a retention bar 136 can be positioned on the printed circuit board 103 to maintain an array of bottom shields 109 in the high-speed cable assembly 100. The retention bar 136 can be designed to hold multiple bottom shields 109 (e.g., four bottom shields 109 as shown in FIG. 3) in a precise arrangement, ensuring proper spacing and alignment of the bottom shields 109 relative to corresponding twinax cables 106. This arrangement can provide consistent shielding performance across the entire cable assembly, improving overall signal integrity and reducing electromagnetic interference between adjacent cable terminations.

In various embodiments, the retention bar 136 may be formed of a nonconductive polymer material, which can help the retention bar 136 maintain electrical isolation between each of the bottom shields 109. At the same time, the polymer material can offer structural integrity to the array of the bottom shields 109, helping to keep the bottom shields 109 in their intended positions even under mechanical stress or vibration. In some embodiments, the retention bar 136 includes locating features corresponding to those of the top shield 112 to further facilitate the coupling of the top shield 112 to the array of bottom shields 109.

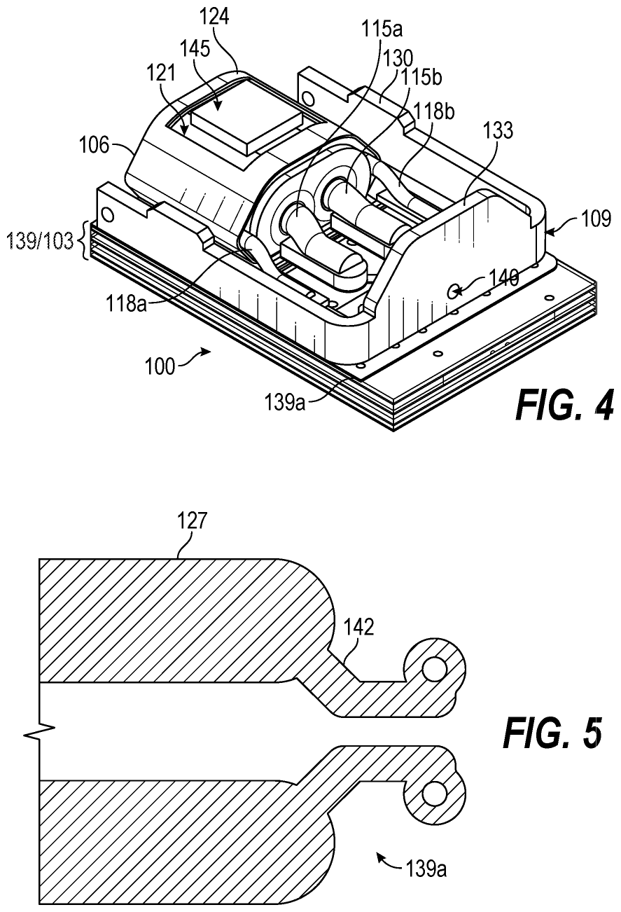

The retention bar 136 can be injection molded, in some implementations. To facilitate this, the ground shield 109 may include one or more apertures 140 (FIG. 4) positioned on various surfaces of the ground shield 109 including, but not limited to, walls of the ground shield 109. During overmolding, molten polymer material forming the retention bar 136 can flow through the apertures 140, creating mechanical interlocks as the material hardens or solidifies on both sides of the ground shield 109. This may securely bond the retention bar 136, as formed of a polymer material, to the ground shield 109, formed of a substantially rigid conductive material, by physically anchoring the polymer in place via the apertures 140, enhancing structural integrity without the need for fasteners or adhesives.

Moving along, FIG. 4 illustrates a sectional perspective view of a single twinax cable 106 terminating to a printed circuit board 103 which is formed up of individual layers that together compose the printed circuit board 103, or a portion thereof. The individual layers are not necessarily depicted to scale, and the thickness of each layer may be emphasized for explanatory purposes.

The printed circuit board 103 in FIG. 4 is shown to be made up of multiple PCB layers 139 (e.g., twelve layers or other number of layers), where each of the PCB layers 139 can have a unique geometry. This, each of the PCB layers 139 can serve a specific purpose in the overall functionality of the high-speed cable assembly 100. The PCB layers 139 may include, for example, signal layers, ground planes, power planes, and insulating layers, and can include various notched regions, windows, via, and so forth. The arrangement and composition of the PCB layers 139 may be optimized to support high-frequency signal transmission and routine, and may minimize electromagnetic interference.

At the top of the printed circuit board 103, as depicted in both FIG. 4 and FIG. 5, is a conductive PCB layer 139a, or a portion thereof. The PCB layer 139a can include a top-most layer having conductive traces that form conductive pads 127 or other conductive portions designed to receive the conductors 115, 118 from the twinax cable 106. The geometry and material composition of these conductive pads 127 may be provided to ensure proper electrical connection and signal integrity at the high frequencies involved in operation of the assembly 100. For instance, conductive pads 127 corresponding to the signal conductors 115 can be provided, where the PCB layers 139a has extending arms 142 that engage with a via to electrically connect the conductive pads 127 to another layer of the printed circuit board 103 for routing signals to appropriate portions of the printed circuit board 103.

Referring again to FIG. 4, the high-speed cable assembly 100 may include a conductive material 145 positioned on an exposed portion of the twinax cable 106, such as the twinax foil 121 exposed through a cut-out region. The exposed portion of the twinax foil 121 may be created through various methods to allow for electrical connection with other components of the assembly. In some implementations, a section of the cable jacket may be cut out or notched to reveal the underlying twinax foil 121. Alternatively, the twinax cable 106 may be manufactured with a pre-formed exposed section of the twinax foil 121 in a location corresponding to where the conductive material 145 will be located.

The conductive material 145 can act as an interface between the exposed twinax foil 121 and other conductive elements of the assembly, such as the top shield 112. The conductive material may take various forms to enhance conductivity and ensure a reliable electrical connection. In some embodiments, the conductive material 145 may be a conductive foam or a conductive thermal paste, which can conform to surface irregularities and provide consistent contact pressure.

The choice of conductive material 145 may depend on factors such as the specific electrical requirements of the assembly, environmental conditions, and manufacturing considerations. Other conductive materials that may be used include conductive adhesives, metal-impregnated elastomers, or specialized conductive compounds. The application of this conductive material 145 to the exposed twinax foil 121 may help to increase overall conductivity between the twinax cable 106 and other shielding components, improving signal integrity and reducing electromagnetic interference in the high-speed cable assembly 100.

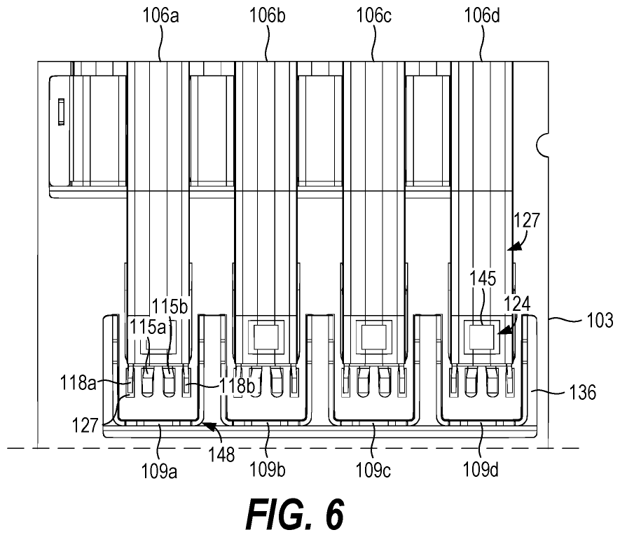

Turning now to FIG. 6, FIG. 6 illustrates a top view of the termination of the twinax cables 106 and their conductors 115, 118 to the printed circuit board 103. The twinax cables 106 terminate to the printed circuit board 103, with their respective signal conductors 115 and ground conductors 118 making contact with the conductive pads 127 on the board surface. The retention bar 136 includes U-shaped cut-outs 148 that are sized and positioned to accommodate each of the bottom shields 109 in the array of bottom shields 109.

The U-shaped cut-outs 148 may be precisely dimensioned to match the profile of the bottom shields 109, allowing for a snug fit that helps maintain the position and alignment of each bottom shield 109. The retention bar 136 with its U-shaped cut-outs 148 may provide structural support to the bottom shields 109, ensuring consistent spacing between adjacent bottom shields 109, and aiding in the assembly process by guiding the placement of the bottom shields 109.

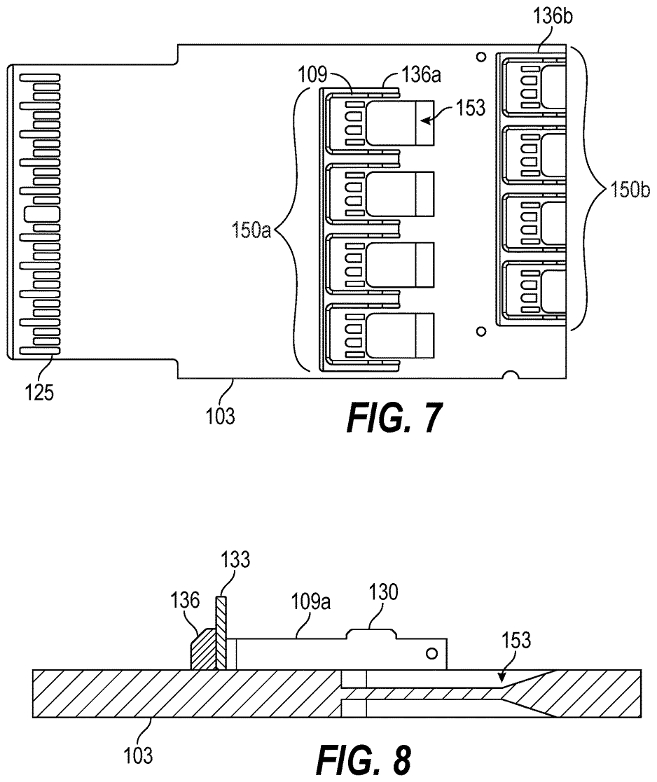

Referring next to FIG. 7, FIG. 7 illustrates a top view of the printed circuit board 103 with two arrays 150a, 150b of bottom shields 109 and corresponding retention bars 136. The twinax cables 106 and associated components are omitted for explanatory purposes. The configuration of the printed circuit board 103 and the arrays 150 of bottom shields 109 may accommodate two rows of twinax cables 106, although a single row or more than two rows can be employed. Each array 150 of bottom shields 109 can be held in place by a retention bar 136, which may be positioned on the printed circuit board 103.

The retention bars 136 may feature U-shaped cut-outs designed to accommodate and align each of the bottom shields 109 in their respective arrays 150. This arrangement may provide structural support and maintain precise spacing between adjacent shields 109 within each row. The dual-array configuration may allow for increased cable density and potentially enhance overall shielding effectiveness in the high-speed cable assembly 100. The bottom shields 109 in each array 150 may be positioned to align with corresponding conductive termination pads 127 on the printed circuit board 103, facilitating proper termination of the twinax cables 106 when installed.

While two arrays 150 of bottom shields 109 are shown, it is understood that, in some embodiments, a single array 150 may be utilized. In alternative embodiments, three or more arrays 150 may be employed, depending on the number of cables 106 desired. The number of arrays 150 may be adjusted to accommodate various cable densities and configurations. For instance, a single array 150 may be suitable for applications requiring fewer twinax cables 106, while multiple arrays 150 may be implemented in high-density designs where a larger number of cables 106 need to be terminated. The flexibility in the number of arrays 150 allows the high-speed cable assembly to be adaptable to different system requirements and space constraints. Each additional array 150 may be accompanied by its own retention bar 136, maintaining the structural integrity and precise alignment of the bottom shields 109 across all rows of twinax cables 106.

A side view of the printed circuit board 103 is illustrated in FIG. 8, showing a bottom shield 109 and a retention bar 136. Referring to FIGS. 7 and 8 collectively, the bottom shield 109 may include a tab 130 and an extension 133 projecting from walls thereof, which may be provided as points for electrical connection or mechanical attachment to the top shield 112 within the assembly 100.

Moreover, the printed circuit board 103 may include troughs 153 that are designed to accommodate the twinax cables 106. For instance, the troughs 153 may allow the twinax cables 106 to partially nest within a surface of the printed circuit board 103, which may help to lower the overall profile of the assembly 100, reducing its total height. Additionally, the troughs 153 may assist in precisely positioning and aligning the twinax cables 106 relative to their termination points on the printed circuit board 103. By recessing the twinax cables 106 slightly into the surface of the printed circuit board 103, the assembly 100 may be better able to withstand mechanical stresses or vibrations that could otherwise affect the integrity of the cable terminations.

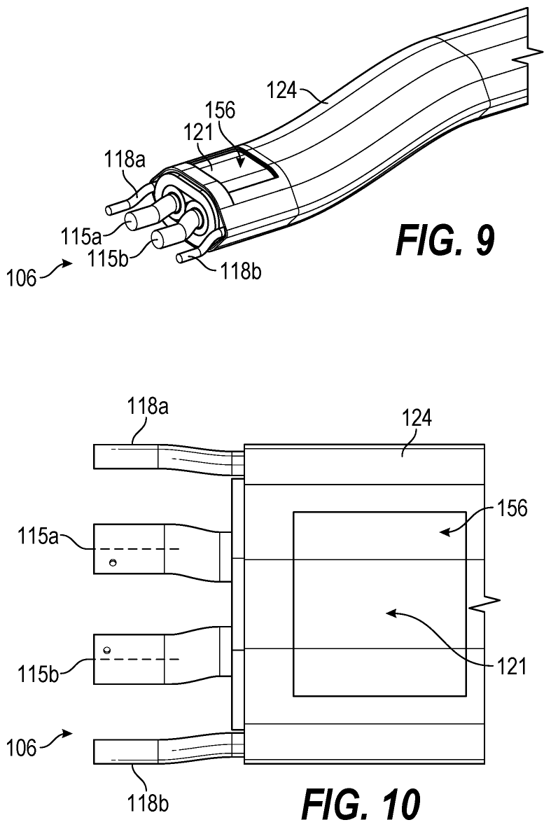

FIG. 9 illustrates a perspective view of a representative twinax cable 106, while FIG. 10 provides a top view of the same twinax cable 106. Referring to FIGS. 9 and 10 collectively, the twinax cable 106 includes signal conductors 115, ground conductors 118, and a cut-out area 156 on the jacket 124 that exposes the twinax foil 121. The signal conductors 115 may be bent downwards and/or outward from one another, which can create a minimum desired distance between the signal conductors 115. In some embodiments, the minimum desired distance is 0.35 mm to 0.49 mm, although other dimensions can be employed. As such, signal integrity can be improved by reducing electromagnetic coupling between the signal conductors 115. Similarly, the ground conductors 118 may be bent downwards and/or outward from one another.

Thus, each of the conductors 115, 118 can include one or more bends. The bends in the signal conductors 115 and ground conductors 118 may be precisely formed to achieve specific impedance characteristics and maintain consistent electrical performance. The angle and extent of the bend may be tailored to the particular requirements of the high-speed cable assembly 100, such as signal frequency, desired impedance characteristics, and overall assembly geometry. In some embodiments, the signal conductors 115 may extend out of the jacket 124 a predetermined distance (e.g., approximately 0.1 mm, 0.2 mm, and so on) before a bend occurs, maintaining precise position control of the signal conductors 115.

The cut-out area 156 on the jacket 124 may be positioned to expose a portion of the twinax foil 121, which typically resides between the jacket 124 and the conductors 115, 118. The exposed section of the twinax foil 121 may facilitate electrical connection with other components of the assembly 100 including, but not limited to, the conductive material 145 or the top shield 112. The size and shape of the cut-out area 156 may be optimized as desired to provide sufficient exposure of the twinax foil 121 and optionally will be configured to ensure the structural integrity of the twinax cable 106 is maintained in a suitable manner. In the depicted embodiment, for example, the cut-out area 156 is rectangular shaped without piercing the end of the jacket but numerous other configurations are possible. The exposed twinax foil 121 in the cut-out area 156 may be treated or prepared to enhance its conductivity or adhesion properties. This preparation may involve cleaning, surface roughening, or the application of conductive coatings to ensure optimal electrical contact with other conductive elements in the assembly.

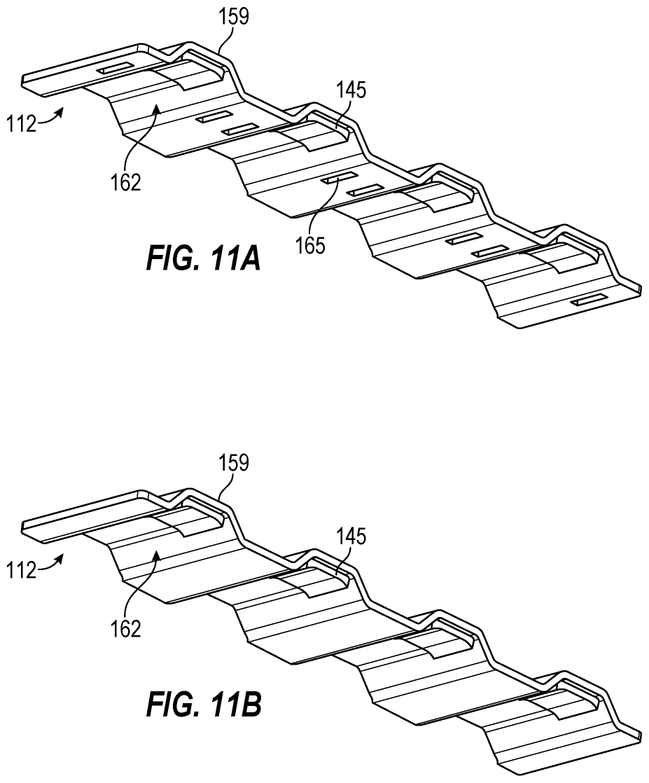

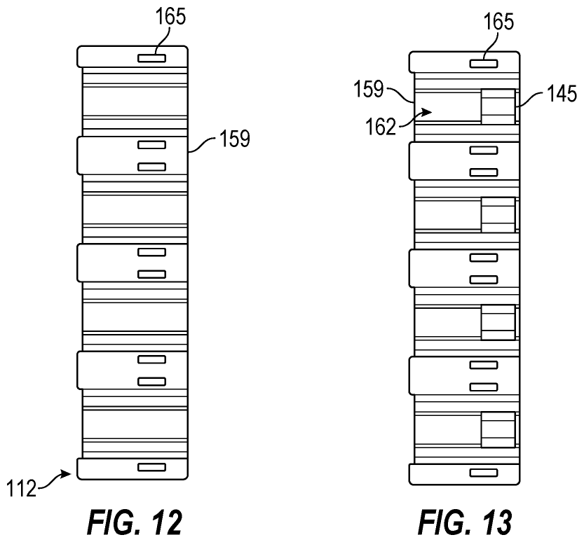

FIGS. 11A and 11B show bottom perspective views of the top shield 112, whereas FIG. 12 and FIG. 13 provide top view and bottom views thereof, respectively. The body of the top shield 112 incorporates various bends that form stepped areas 159 defining channels 162. These channels 162 may be designed to accommodate the jackets 124 of the twinax cables 106 or other portions thereof.

The conductive material 145 can be positioned on the bottom surface of the top shield 112, including within the channels 162. As such, the conductive material 145 can align with the cut-out areas 156 and the exposed twinax foil 121 of the cables when the assembly 100 is formed. As can be appreciated, therefore, the conductive material 145 can be positioned in the desired location by different manufacturing processes, such as, without limitation, positioning the conductive material 145 on the cable or on the top shield 112. While individual pieces are depicted, it is also possible to have the conductive material extend around multiple twinax cables 106. Further, the bends in the top shield 112 enable the top shield 112 to closely surround the termination regions of the twinax cables 106. The close-fitting nature of the top shield 112 may provide additional grounding capabilities to the assembly 100. For instance, the proximity of the conductive top shield 112 to the cable terminations may help in managing electromagnetic interference and improving signal integrity. As can be appreciated, the top shield 112 may be fabricated from a substantially rigid conductive material, such as a metal or a metalized polymer.

Referring to FIGS. 11A, 12, and 13 the body of the top shield 112 may include one or more notches 165 that interface with tabs 130 on the bottom shields 109 to form a mechanical connection with the bottom shields 109 in the array 150. Thus, the notches 165 may be precisely positioned and sized to correspond with the tabs 130 on the bottom shields 109, allowing for a secure fit when the top shield 112 is assembled onto the array 150. The interaction between the notches 165 and tabs 130 may provide stability to the overall assembly, and may maintain proper alignment and electrical continuity between the top shield 112 and the bottom shields 109. In some implementations, the notches 165 may be designed to create a snap-fit or friction-fit connection with the tabs 130, which can simplify assembly and reduce the need for additional fasteners. Alternatively, in some embodiments, the notches 165 serve as locations for welding or soldering the tabs 130 to the top shield 112. Welding may include laser welding, which can provide precise and localized heat to create a connection between the tabs 130 and the top shield 112. Alternatively, the top shield 112 may not include any notches 165, as shown in FIG. 11B. In this embodiment, the top shield 112 may be welded or otherwise affixed to one or more of the bottom shields 109 without tabs 130 or like components.

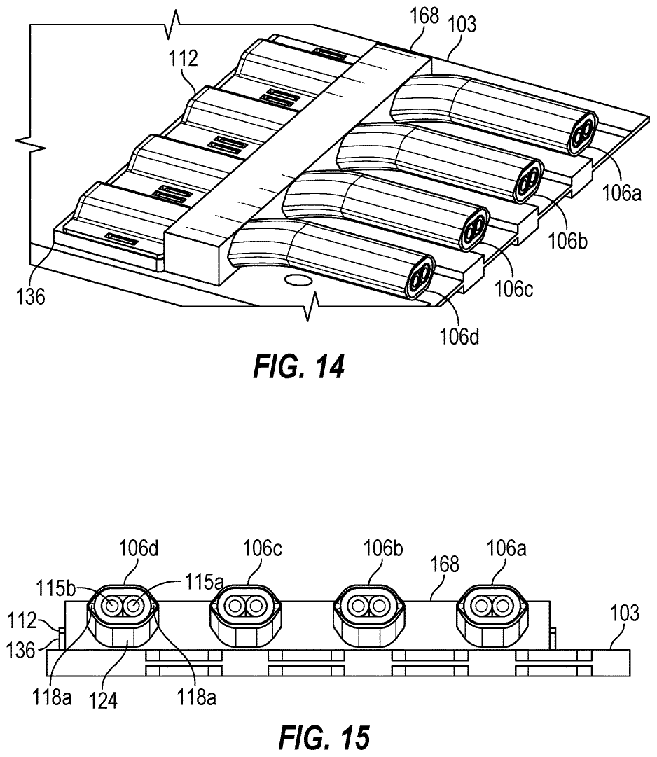

Referring now to FIGS. 14 and 15, FIG. 14 is a rear, top perspective view of the assembly 100 and FIG. 15 is a rear elevation view thereof. Referring to FIGS. 14 and 15 collectively, the assembly 100 can further include a stabilizer bar 168 in various embodiments. The stabilizer bar 168 can include a single, integral body that can be positioned between the top shield 112 and remaining portions of the body of individual ones of the twinax cables 106. The stabilizer bar 168 may extend laterally across the printed circuit board 103 parallel to the top shield 112 and the array of bottom shields 109. Thus, the stabilizer bar 168 can extend across multiple twinax cables 106, providing support and maintaining alignment of the cables near their termination points on the printed circuit board 103. In some embodiments, the stabilizer bar 168 is positioned parallel to and contacts the retention bar 136.

In some embodiments, the stabilizer bar 168 may be overmolded, which may allow the stabilizer bar 168 to conform closely to the contours of the twinax cables 106 and the top shield 112, creating a snug fit. In any event, the stabilizer bar 168 may be configured to provide strain relief close to the termination area of the cables 106. By supporting the cables 106 near their connection points, the stabilizer bar 168 may help absorb and distribute external forces that might otherwise be transmitted directly to the terminations. The stabilizer bar 168 may also include channels having a cross-section that closely conformed to a cross-section of the individual twinax cables 106, enhancing cable alignment and separation.

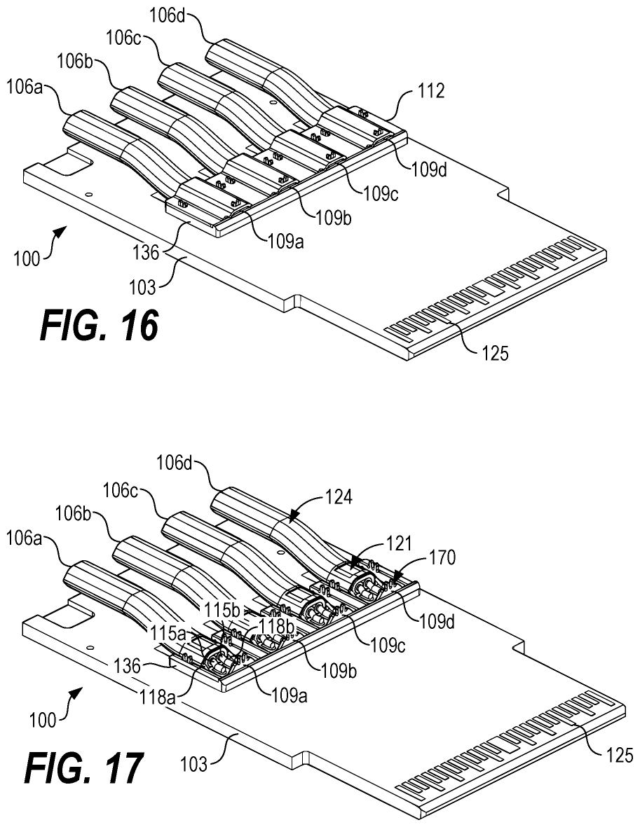

Referring to FIGS. 16 and 17, embodiments similar to those shown in FIGS. 1 and 2 are shown. However, in contrast with the embodiment of FIGS. 1 and 2, each of the walls of the bottom shields 109 may include one or more projections 170, which in the depicted embodiment are rabbit-ear shaped. For instance, each projection 170 can include two elongated members angled in opposing directions. The projections 170 may be designed to slightly flex or deform for insertion into the notches 165 of the top shield 112. When positioned in the notches 165, the projections 170 return to their non-deformed state, and help bias the bottom shield and top shield together and/or create an interference fit between the bottom shields 109 and the top shield 112.

The projections 170 may extend outward from the walls of the bottom shields 109 and may be shaped to correspond with the dimensions and geometry of the notches 165 in the top shield 112. When assembled, the projections 170 may engage with the notches 165, providing a secure mechanical connection between the bottom shields 109 and the top shield 112 without the need for additional fastening methods such as welding or soldering. The projections 170 can simplify the assembly process by allowing for a quick and tool-free connection between the bottom shields 109 and the top shield 112. The interference fit may also provide flexibility in the connection, allowing for slight adjustments or realignment during assembly while still maintaining a secure connection. In some embodiments, the projections 170 are integral with the bottom shields 109. The projections 170 can be sized and positioned to provide a balance between ease of insertion and the strength of the resulting connection.

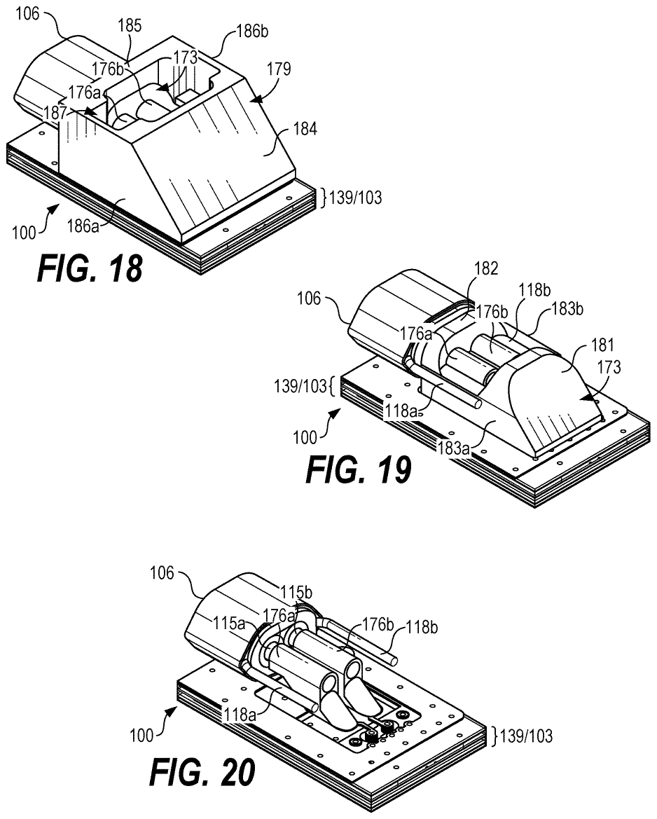

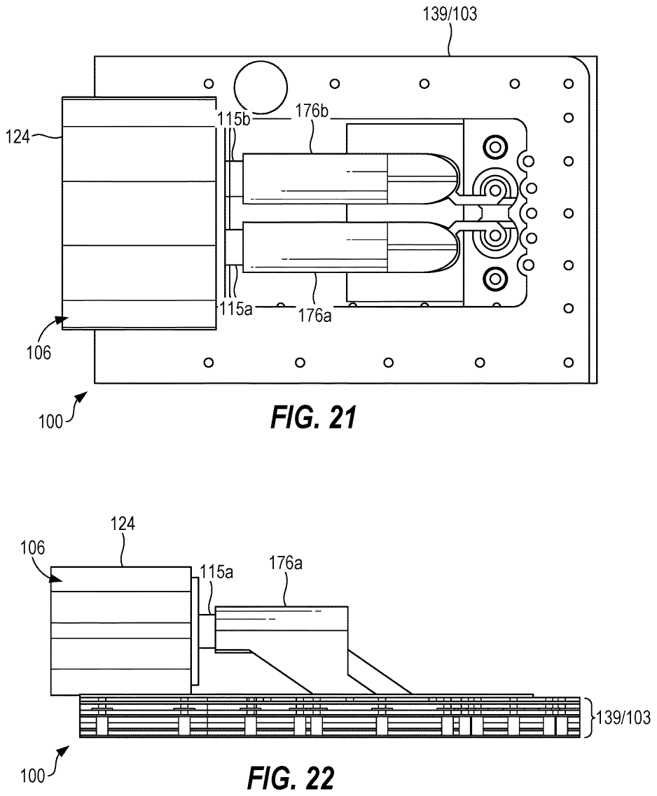

Referring collectively to FIGS. 18-22, FIG. 18 is a top perspective view of a high-speed cable assembly 100 featuring a ground shield 179 and a retention device 173 according to various embodiments of the present disclosure. FIG. 19 is a top perspective view thereof with the ground shield 179 omitted, and FIGS. 20-22 are various view thereof with the ground shield 179 and the retention device 173 omitted for explanatory purposes. FIGS. 21 and 22 further omit the ground conductors 118 from view for explanatory purposes.

According to various embodiments, the retention device 173 can be formed of a resin such as liquid crystal polymer (LCP) or other non-conductive material. The retention device 173 may be designed to securely hold or otherwise maintain the signal conductors 115 and/or the ground conductors 118 relative to a ground shield 179. For instance, in some embodiments, the retention device 173 may securely hold or maintain crimp tubes 176a, 176b (collectively “crimp tubes 176”) that surround one or more of the conductors 115 and/or conductors 118. In an embodiment, the crimp tubes 176 can be formed from a conductive material such as a plated plastic, a conductive plastic, or a metal alloy and can be soldered or welded or conductively adhered to the conductors. To this end, the retention device 173 may be sized and positioned to maintain the crimp tubes 176 relative to the ground shield 179, which may be fabricated from metal or other conductive materials. This arrangement may help to ensure consistent grounding and shielding performance across terminations of a twinax cable 106.

The retention device 173 can include a front end 181, a rear end 182, and side walls 183a, 183b (collectively “side walls 183”) extending between the front end 181 and the rear end 182. The rear end 182 may include an aperture to accommodate each of the signal conductors 115. For instance, if there are two signal conductors 115, there may be two apertures in the rear end 182 and so on. The front end 181 can be sloped downwards, e.g., from a position closer to the rear end 182 to a position farther from the rear end 182, as shown in FIG. 20.

Likewise, the ground shield 179 can include a front end 184, a rear end 185, and side walls 186a, 186b (collectively “side walls 186”) extending between the front end 181 and the rear end 182. The rear end 182 may include an aperture to accommodate each of the signal conductors 115. For instance, if there are two signal conductors 115, there may be two apertures in the rear end 182. The front end 181 can be sloped from a position closer to the rear end 182 to a position farther from the rear end 182, as shown in FIG. 20. The ground shield 179 can further include a window 187, where the crimp tubes 176, the signal conductors 115, and/or the ground conductors 118 can be viewable or accessible.

In some embodiments, the ground conductors 118 extend into and contact the ground shield 179 to provide shielding between the twinax cable 106 and the ground shield 179. As such, the ground shield 179 can provide electromagnetic shielding and act as a structural support device, supporting the crimp tubes 176 and associated conductors 115, 118. The retention device 173 may interface with the ground shield 179 in a manner that allows for secure attachment while maintaining electrical isolation between the conductive elements and the non-conductive retention device 173. In some embodiments, the ground shield 179 forms a snap or interference connection with the retention device 173. FIGS. 18-20 further illustrate various ones of the PCB layers 139 of the printed circuit board stackup within the high-speed cable assembly 100.

The PCB layers 139 may incorporate features that complement the retention device 173 and the ground shield 179. For example, certain layers of the printed circuit board 103 may include pads or traces specifically designed to interface with the crimp tubes 176 or the ground shield 179. In some implementations, the printed circuit board 103 may include dedicated PCB layers 139 that connect directly to the ground shield 179, enhancing the overall shielding effectiveness of the assembly 100. As shown in FIG. 19, the crimp tubes 176 has a first portion that extends laterally with the signal conductors 115, then extend downward at an angle to contact a top surface of the printed circuit board 103.

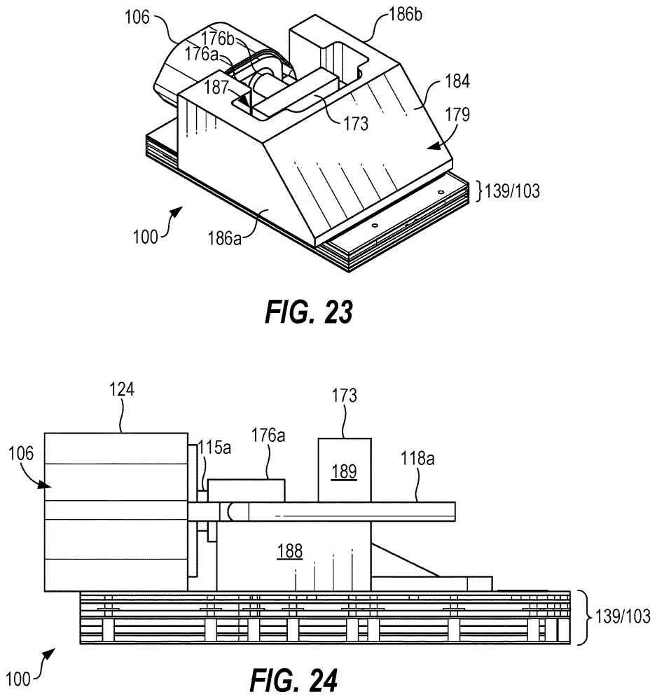

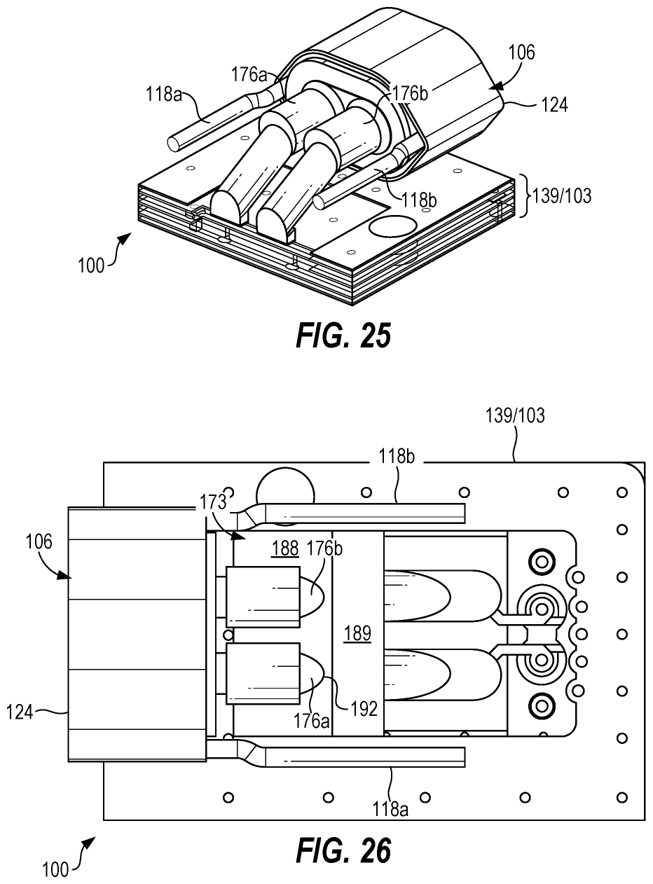

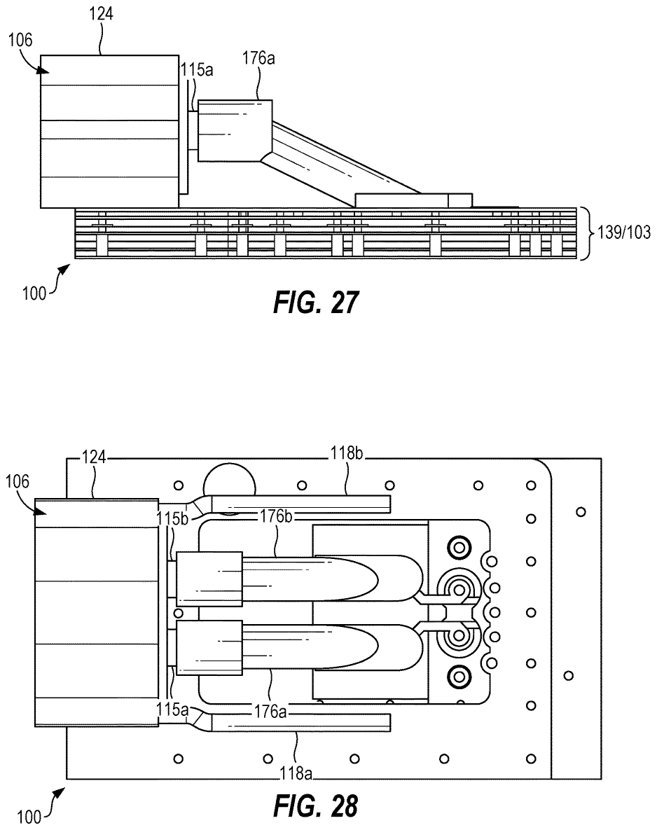

Moving along, FIG. 23 is a top perspective view of a high-speed cable assembly 100 featuring a ground shield 179 and a retention device 173 according to various embodiments of the present disclosure. FIG. 24 is a side view of the assembly 100 with the ground shield 179 omitted, FIG. 25 is a perspective view with the ground shield 179 and the retention device 183 omitted for explanatory purposes, and FIG. 26 is a top elevation view with the ground shield 179 omitted for explanation. Further, FIG. 27 is a side elevation view and FIG. 28 is a top elevation view with the ground shield 179 and the retention device 183 omitted for explanatory purposes.

Referring to FIGS. 23-28 collectively, the ground shield 179 includes a front end 184 and two L-shaped side walls 186a, 186b having projections that extend along a rear end of the ground shield 179. The rear end 185 does not include a continuous wall with apertures. Instead, the rear end 185 includes a channel defined by the two L-shaped side walls 186 to receive the signal conductors 115. The ground conductors 118 may extend into apertures located in the side walls 186 in some implementations, or may be further positioned in the channel. The ground shield 179 can further include a window 187, where the crimp tubes 176, the signal conductors 115, and/or the ground conductors 118 can be viewable or accessible.

The retention device 173 may include a rectangular-body portion 188 integral with a vertically-extending portion 189. The rectangular-body portion 188 and/or the vertically-extending portion 189 may define one or more apertures 192 through with the signal conductors 115 may be positioned. FIGS. 27 and 28 have the retention device 173 omitted such that the orientation of the crimp tubes 176 and the signal conductors 115 contained therein can be seen are terminating to the printed circuit board 103.

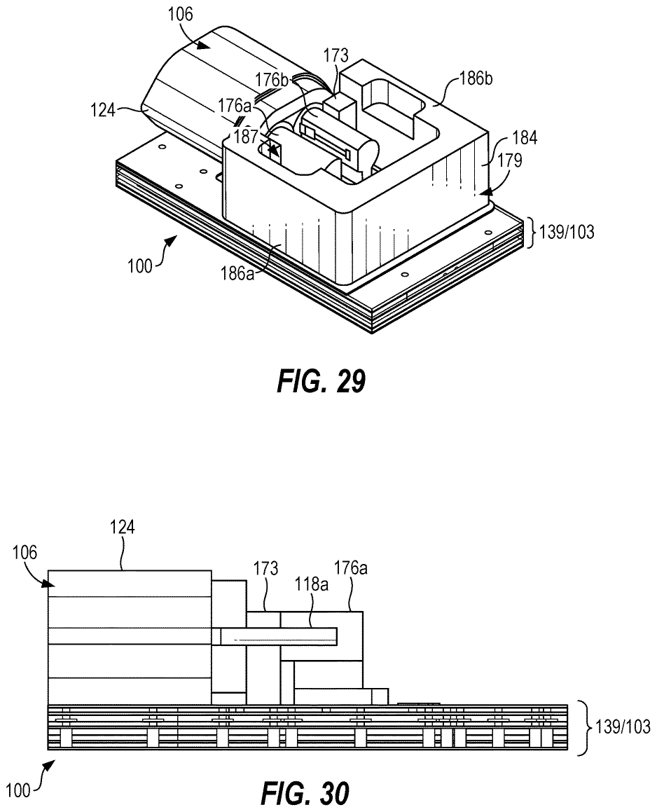

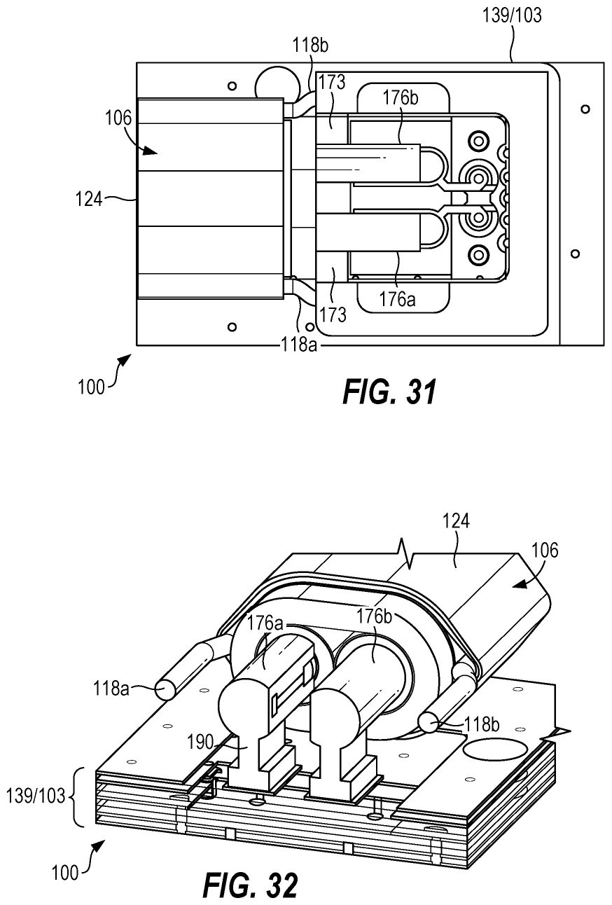

Turning now to FIGS. 29-32, FIGS. 29-32 illustrate additional embodiments of a ground shield 179 and a retention device 173. FIG. 29 is a top perspective view of a cable assembly 100 having a ground shield 179 and a retention device 173, FIG. 30 is a side elevation view thereof, and FIG. 31 is a top elevation view thereof according to various embodiments. FIG. 32, showing a front perspective view of the assembly 100, has the ground shield 179 and the retention device 173 omitted for explanatory purposes.

Referring to FIGS. 29-32 collectively, the ground shield 179 includes U-shaped body having a front end 184 and sides 186a, 186b extending from each side of the front end 184. The sides 186 collectively define a channel in which the signal conductors 115 and/or crimp tubes 176 are positioned and terminated to the printed circuit board 103. The retention device 173 includes a U-shaped body, having a first vertical side projecting upwards, a second vertical side projecting upwards, and a lateral portion connecting the first vertical side and the second vertical side. The lateral portion may be positioned on a top surface of the printed circuit board 103, which may support the signal conductors 115 and/or the crimp tubes 176. A width of the retention device 173 may be the same as or substantially similar to a width of the channel defined by the sides 186a, 186b, facilitating a snug arrangement of the components.

As shown in FIG. 32, the crimp tubes 176 can extend laterally in a common direction relative to the signal conductors 115, and can include crimped portions that cause a cross-section of the crimp tubes 176 to be semi-circular. Moreover, the crimp tubes 176 include standoff portions 190 that extend vertically and electrically terminate the crimp tubes 176 and the signal conductors 115 to the printed circuit board 103 or like substrate. The standoff portions 190 can include a base portion having a width wider than a middle portion, where the middle portion can terminate into the semi-circular cross-sectional portion of the crimp tubes 176. It should be noted that the retention device 173 is shown as a wall in some of the figures, but could be configured to be more similar to the retention device 173 shown in FIG. 19.

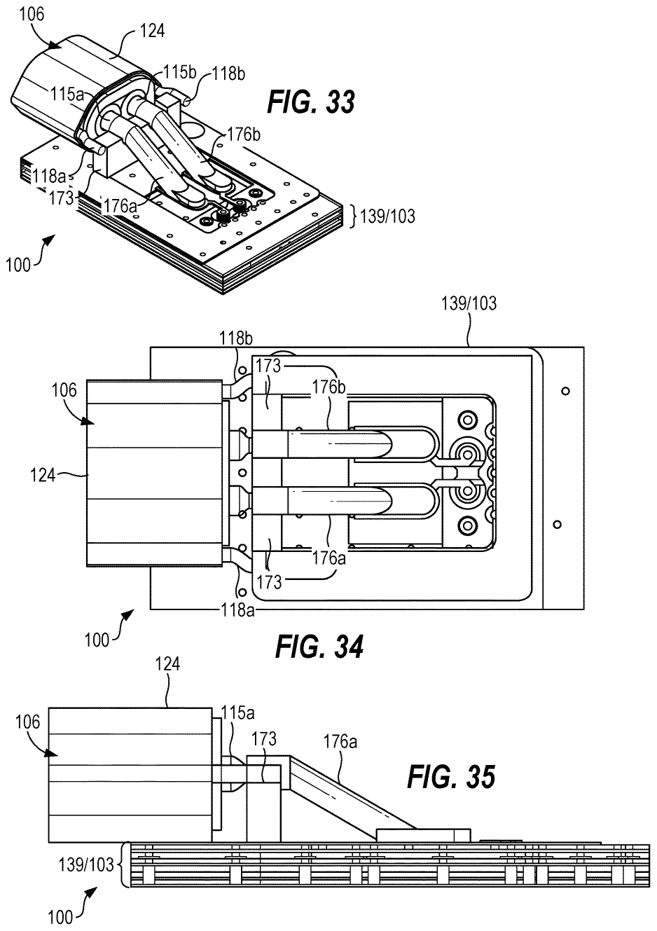

Moving along, FIGS. 33-35 illustrate additional embodiments of a ground shield 179 and a retention device 173. FIG. 33 is a top perspective view of a cable assembly 100 having a ground shield 179 and a retention device 173, FIG. 34 is a top elevation view thereof, and FIG. 35 is a side elevation view thereof according to various embodiments.

Referring to FIGS. 33-35 collectively, the retention device 173 includes a single integral body portion generally rectangular that is positioned perpendicular to the jacket 124 of the twinax cable 106 and/or a longitudinal axis of the printed circuit board 103. A bottom of the retention device 173 is positioned on a top surface of the printed circuit board 103. The retention device 173 includes a U-shaped notch to accommodate each of the signal conductors 115 and/or the crimp tubes 176. The U-shaped notch can have an inner diameter that closely conforms to an outer diameter of the signal conductors 115 or the crimp tubes 176, if present. Thus, the retention device 173 can support the signal conductors 115 as they exit the jacket 124 of the twinax cable 106, providing support at a potential location for strain.

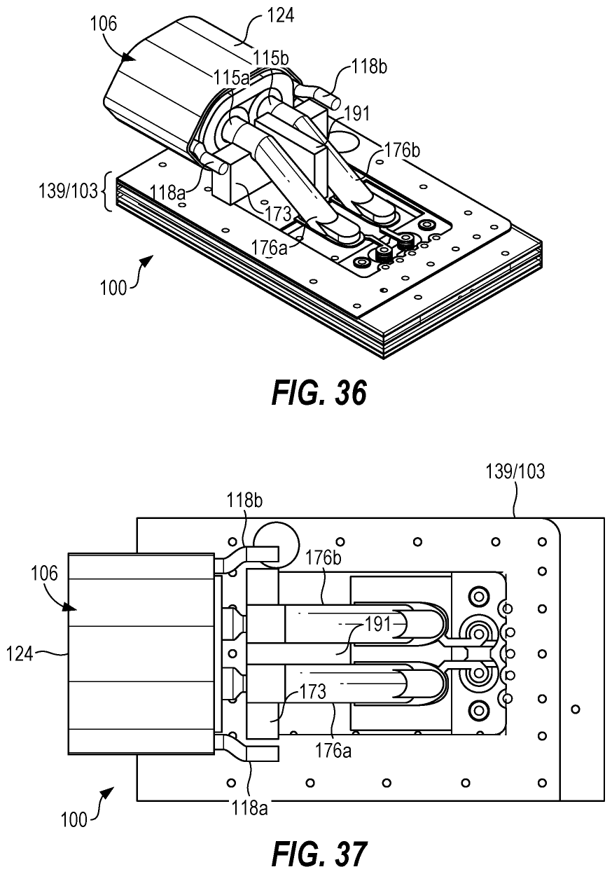

Next, FIGS. 36-37 illustrate additional embodiments of a ground shield 179 and a retention device 173. FIG. 36 is a top perspective view of a cable assembly 100 having a ground shield 179 and a retention device 173 and FIG. 37 is a top elevation view thereof according to various embodiments. Referring to FIGS. 36-37 collectively, the retention device 173 is similar to that of FIGS. 33-35. However, the retention device 173 further includes a lateral support member 191 that extends perpendicular from a middle portion of the retention device 173. The retention device 173 further includes the U-shaped notches to accommodate each of the signal conductors 115 and/or the crimp tubes 176

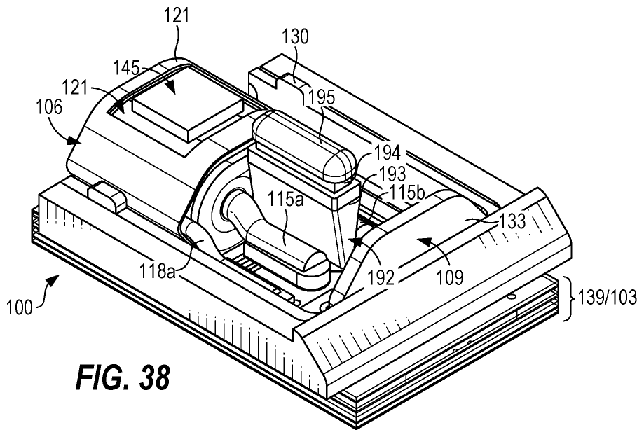

Turning now to FIG. 38, another embodiment of the bottom shield 109 of FIGS. 1-4 are shown according to various embodiments. The signal conductors 115 do not include crimp tubes 176 in FIG. 38; however, it is understood that, in some embodiments, crimp tubes 176 can be employed. The signal conductors 115 can include a downwards bend to cause the signal conductors 115, extending from a middle of a plane of the jacket 124, to electrically couple to the printed circuit board 103. The signal conductors 115 can be cut, coined, or crimped at a portion that contacts the printed circuit board 103, and can be soldered, welded, or otherwise permanently affixed to the printed circuit board 103.

In some embodiments, the assembly 100 includes a retention device 192 that can be formed of a non-conductive material, such as LCP or other suitable polymer. Theretention device 192 can be part of another retention device 173 positioned in the assembly 100 or other non-conductive portion of the assembly 100. A body of the retention device 192 can include a wedge-shaped bottom section 193, a neck section 194, and a protruding section 195. The wedge-shaped bottom section 193 of the retention device 192 can be generally triangular-shaped, and can have tapered edges that causes a width of the wedge-shaped bottom section 192 at a lower portion thereof (e.g., between the signal conductors 115) to be less than a width of the wedge-shaped bottom section 192 at a higher portion (e.g., above the signal conductors 115) as coupled to the neck section 194. The wedge-shaped bottom section 192 can be positioned between a pair of signal conductors 115 to prevent signal interference between the respective signal conductors 115, as can be appreciated.

The neck section 194 can be situated in a notch or aperture of another component of the assembly 100 (e.g., a non-conductive structural support component, a non-conductive housing portion, etc.) that is not illustrated for explanatory purposes. The protruding section 195 can provide an interference connection with the other component, where the neck section 194 is retained in the notch or aperture, where the protruding section 195, by virtue of its shape and size relative to the neck section 194, prevents dislodgement of the neck section 194.

While various embodiments described herein refer to twinax cables 106, it is understood that the principles and techniques disclosed may be applied or employed with other types of cables. For example, the high-speed cable assembly 100 may incorporate coaxial cables, twisted pair cables, fiber optic cables, or multi-conductor cables. In some implementations, the assembly may utilize shielded twisted pair cables, unshielded twisted pair cables, or quad cables. The shielding and termination techniques described may also be adapted for use with ribbon cables, flat flexible cables, or micro-coaxial cables. Additionally, the assembly 100 may be configured to accommodate hybrid cables that combine multiple cable types within a single jacket, such as those used in audio/video applications or specialized industrial equipment.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A high-speed cable assembly, comprising:
a printed circuit board;
a twinax cable having a pair of signal conductors and a pair of ground conductors mounted to conductive pads on the printed circuit board;
a bottom shield comprising a U-shaped conductive material positioned around the twinax cable to shield a termination of the pair of signal conductors and the pair of ground conductors on three sides; and
a top shield electrically connected to the bottom shield.

2. The high-speed cable assembly of claim 1, further comprising a conductive foam electrically connecting the top shield to a twinax foil of the twinax cable.

3. The high-speed cable assembly of claim 1, wherein the printed circuit board comprises multiple layers, at least a portion of the layers each having a unique geometry.

4. The high-speed cable assembly of claim 1, further comprising a stabilizer bar positioned between the top shield and a body of the twinax cable to stabilize terminations to the printed circuit board, the stabilizer bar being formed of a non-conductive material.

5. The high-speed cable assembly of claim 1, wherein the bottom shield comprises at least one tab projecting from a wall thereof for electrical connection to the top shield.

6. The high-speed cable assembly of claim 5, wherein the top shield comprises a notch configured to interface with the tab of the bottom shield.

7. The high-speed cable assembly of claim 1, wherein the twinax cable comprises a cut-out area on a jacket that exposes a twinax foil, the cut-out area positioned to align with a conductive material on a bottom surface of the top shield.

8. The high-speed cable assembly of claim 1, wherein the printed circuit board comprises a trough configured to accommodate a portion of the twinax cable.

9. A high-speed cable assembly, comprising:
a printed circuit board having a trough;
a twinax cable partially nested within the trough of the printed circuit board, the twinax cable having a jacket with a cut-out area exposing a twinax foil;
a bottom shield comprising a U-shaped conductive material positioned around the twinax cable;
a top shield; and
a conductive material electrically connecting the top shield to the exposed twinax foil.

10. The high-speed cable assembly of claim 9, wherein the conductive material comprises a conductive foam or a conductive thermal paste.

11. The high-speed cable assembly of claim 9, wherein the bottom shield comprises a tab projecting from a wall thereof for electrical connection to the top shield, and the top shield comprises a notch configured to interface with the tab or extension of the bottom shield.

12. The high-speed cable assembly of claim 9, wherein the twinax cable comprises a pair of signal conductors and a pair of ground conductors mounted to conductive pads on the printed circuit board.

13. The high-speed cable assembly of claim 12, wherein the signal conductors and ground conductors are bent downwards and outward from one another.

14. The high-speed cable assembly of claim 9, further comprising a stabilizer bar positioned between the top shield and a body of the twinax cable to stabilize terminations to the printed circuit board, wherein the stabilizer bar is overmolded between the top shield and the body of the twinax cable.

15. The high-speed cable assembly of claim 9, wherein the printed circuit board comprises multiple layers, each layer having a unique geometry.

16. A high-speed cable assembly, comprising:
a printed circuit board;
a twinax cable mounted to the printed circuit board;
a bottom shield comprising a U-shaped conductive material positioned around the twinax cable;
a top shield;
a retention bar positioned on the printed circuit board to maintain the bottom shield; and
a stabilizer bar positioned between the top shield and a body of the twinax cable.

17. The high-speed cable assembly of claim 16, wherein the twinax cable comprises a pair of signal conductors and a pair of ground conductors mounted to conductive pads on the printed circuit board.

18. The high-speed cable assembly of claim 17, wherein the signal conductors and ground conductors are bent downwards and outward from one another.

19. The high-speed cable assembly of claim 18, wherein the twinax cable comprises a jacket with a cut-out area exposing a twinax foil and further comprising a conductive material electrically connecting the top shield to the exposed twinax foil, wherein the conductive material comprises a conductive foam.

20. The high-speed cable assembly of any one of claims 16, wherein the printed circuit board comprises a trough configured to accommodate a portion of the twinax cable.
